(19) United States
(12) Patent Application Publication
(10) Pub. No.: US 2026/0308988 A1
(43) Pub. Date: Oct. 8, 2026

(54) Threaded Joint

(71) Applicant: Diversity Technologies Corporation, Edmonton (CA)

(72) Inventor: Stephane Perron, Edmonton (CA)

(21) Appl. No.: 19/479,478

(22) PCT Filed: Apr. 25, 2024
(86) PCT No.: PCT/CA2024/050543

§ 371 Date: Oct. 28, 2025

Related U.S. Application Data
(60) Provisional application No. 63/462,690, filed on Apr. 28, 2023.

(51) Int. Cl. E21B 17/042; F16L 15/06

(52) U.S. Cl. CPC E21B 17/042; F16L 15/06

(57) ABSTRACT

There is disclosed a threaded joint for coupling together rods, tubes, pipes etc. The joint consists of helical box and pin thread segments each defined by a pressure flank and a clearance flank spaced apart from each other with alternating roots and crests. The pressure flank is defined by an S-curve extending between the root and upward toward the crest, which is defined by a first curvature c1 adjacent to the root and a second curvature c2 toward the crest. c1 and c2 curve in opposing directions with an inflection point between curvatures c1 and c2. c1 and/or c2 comprise a compound curvature comprising a segment of a first circle having a radius R2, a segment of a second circle having a radius R3, and a segment of a third circle having a radius R4. In addition, the clearance flank may comprise a curvature c4 comprising a second compound curvature, the second compound curvature comprising a segment of a first circle having a radius R5, and a segment of a second circle having a radius R6. A sloped linear segment may connect the second curvature with the crest.

### FIELD

The invention relates to threaded joints for coupling together of rods, tubes, pipes, and shafts, with particular application for subsurface drilling pipes and tubes.

### BACKGROUND

Subsurface drilling, particularly for mineral exploration, involves the use of a rotating drill string assembled from multiple individual tubular rods that are coupled together as the drilling progresses. Typically, the rods are threaded together using threading that is provided at opposing ends of each rod. Significant axial and rotational stresses are placed on the threading during the drill rotation and drill string retraction. Furthermore, the rods should be coupled together and decoupled without the need to apply excessive torque or force to the drill rod segments.

Within the mining industry, there is an ongoing need to provide improved threaded joints, such as those used on thin-walled tubing (less than 0.25″ wall thickness), to address some of the drawbacks that are present within prior art threaded joints.

### SUMMARY

We describe a threaded joint for coupling together first and second members, in which each of said members comprises a central axis between respective ends thereof. The joint consists of threaded segments located on at least one end of the members, in which members may be coupled together by threading the respective segments together. In one aspect, the invention relates to a modified “buttress” thread that is self-locking.

In one aspect, the joint comprises a pin thread segment at one end of a first of said members and a tubular box thread segment at one end of a second of said members, in which the box thread segment and pin thread segment each comprise a helical thread defined by a pressure flank and a clearance flank. The box thread segment and pin thread segment each further comprises a root and a crest extending between said pressure flank and said clearance flank, wherein the pressure flank comprises an S-curve (when viewed in cross-section along an axial section) extending between the root and the crest. The S-curve is defined by a first curvature c1 extending from the root and a second curvature c2 extending from the crest with an inflection point “i” between curvatures c1 and c2. Curvatures c1 and c2 are opposed, whereby c1 is concave and c2 is convex. The S-shaped curvature of the pressure flank may extend from adjacent to the root to adjacent to the crest.

In another aspect, there is provided a threaded joint for coupling together first and second members, each of said members having a central axis between respective ends thereof, said joint comprising: a pin thread segment at one end of said first member; and a tubular box thread segment at one end of said second member. Said box thread segment and said pin thread segment each comprising: a helical thread defined by a pressure flank and a clearance flank spaced apart from each other with alternating roots and crests extending between said pressure flanks and clearance flanks. Said pressure flank comprises an S-curve extending between the root and the crest, said S-curve defined by a first curvature c1 adjacent to the root and a second curvature c2 adjacent to the crest, c1 and c2 curving in opposing directions with an inflection point between said curvatures c1 and c2. c1, c2, or both c1 and c2, comprises: a compound curvature comprising a segment of a first circle having a radius R2, a segment of a second circle having a radius R3, and a segment of a third circle having a radius R4.

In yet another, there is provided a threaded joint for coupling together first and second members, each of said members having a central axis between respective ends thereof, said joint comprising: a pin thread segment at one end of said first member; and a tubular box thread segment at one end of said second member. Said box thread segment and said pin thread segment each comprising: a helical thread defined by a pressure flank and a clearance flank spaced apart from each other with alternating roots and crests extending between said pressure flanks and clearance flanks. Said pressure flank comprises an S-curve extending upward from the root toward the crest, said S-curve defined by a first curvature c1 adjacent to the root and a second curvature c2, c1 and c2 curving in opposing directions with an inflection point between said curvatures c1 and c2, wherein c1, c2, or both c1 and c2, comprises a compound curvature, and wherein a sloped linear segment connects the second curvature with the crest.

In a further aspect, there is provided a threaded joint for coupling together first and second members, each of said members having a central axis between respective ends thereof, said joint comprising: a pin thread segment at one end of said first member; and a tubular box thread segment at one end of said second member. Said box thread segment and said pin thread segment each comprising: a helical thread defined by a pressure flank and a clearance flank spaced apart from each other with alternating roots and crests extending between said pressure flanks and clearance flanks. Said pressure flank comprises an S-curve extending upward from the root toward the crest, said S-curve defined by a first curvature c1 adjacent to the root and a second curvature c2, c1 and c2 curving in opposing directions with an inflection point between said curvatures c1 and c2. c1, c2, or both c1 and c2, comprises a first compound curvature. The clearance flank comprises a curvature c4 comprising a second compound curvature, the second compound curvature comprising a segment of a first circle having a radius R5, and a segment of a second circle having a radius R6.

In one aspect, curvature c1 equals c2 in opposed directions. One or both of c1 or c2 may comprise a segment of a circle having a radius r1.

Alternatively, one of both of c1 or c2 may comprise a compound curvature comprising a segment of a first circle having a radius r1 and a segment of a second circle having a radius r2 wherein r1 does not equal r2. In one aspect, r2 may be greater than r1.

In another aspect, the crest and root surfaces of said box and pin thread segments may each define a frustoconical surface, in which the angle of taper may be within the range of 0.75° and 1.63° relative to said central axis.

In a further aspect, the pin thread segment and box thread segment each comprises a first and second unthreaded segments at opposing ends of the helical thread, the first unthreaded segment is at a distal end of the member and having an end face defining the distal end surface of the first member. The second unthreaded segment has a radially inwardly stepped shoulder. The shoulders may each be angled relative to the perpendicular of the central axis within the range of 5 to 15 degrees. Alternatively, the shoulders may each comprise an inner region adjacent to the unthreaded segment comprising a negative slope of 12° to 15° relative to the perpendicular of the central axis and an outer region which is perpendicular to the central axis or has a negative slope of up to 4° relative to the perpendicular. The end face may comprise a mirror-image of the compound slope of the shoulder.

According to a further aspect, the clearance flanks may have a positive slope relative to the central axis by about 45°, about 60° or between 45° and 60°.

According to a further aspect, the inflection point i has a tangent with a slope relative to the central axis that is about 45°, about 60° or between 45° and 60°.

The helical thread may comprise either an unpaired helix comprising single-start thread or a paired helix comprising a double-start thread.

In a further aspect, the ratio of r1:r2 above is about 1:3 or greater.

In a further aspect, r1 is within the range of 0.007 inches to 0.015 inches.

In a further aspect, r1 is 0.005 inches to 0.012 inches and r2 is 0.024 inches to 0.060 inches.

Dimensions herein are normally provided in imperial measurements, unless otherwise specified. Directional references herein are normally with reference to the threaded tubular members being horizontal. The terms “inner”, “inwardly” and similar terms refer to the direction that is radially inwardly towards the central axis of a given threaded member. The terms “outer”, “outwardly” and the like refer to the opposed direction which is radially outwardly from the central axis.

References herein to angular deviations are generally expressed in terms of an angle from the central axis of the elongate member or, if specified, a plane which is perpendicular to the axis. The assumption is made herein that the central axis of the threaded coupling is linear. However, the present invention is equally applicable to curved members in which the central axis is non-linear. In such case, angular deviations may be considered to be based on a short segment of the central axis which closely approximates a straight line.

In an aspect, there is provided a threaded joint part comprising: a body, a helical thread having a trapezoid profile and extending around the body, the helical thread having flat crests and flat roots, a pressure flank and a clearance flank spaced apart from each other with alternating roots and crests extending between the pressure flank and the clearance flank, the helical thread having a tapered leading section having a first end and second end, the first end starting proximate at an end of the body, the leading section tapered from the second end to the first end, an angular crest located between the second end of the tapered leading section and the flat crests.

### BRIEF DESCRIPTION OF THE DRAWINGS

FIG. 1 is a cross-sectional view of threaded couplings disposed on the respective end segments of an elongate tubular member, according to one embodiment.

FIG. 2 is an axial cross-sectional view of portions of threaded members showing box and pin threads in expanded view.

FIG. 3 is an expanded view of box and pin thread portions, showing end sections thereof.

FIG. 4 is a view similar to FIG. 3 showing opposing end sections thereof.

FIG. 5 is an enlarged axial cross-sectional view showing portions of the box and pin thread segment of the tubular member.

FIG. 6 is a further enlarged view showing a box threaded section.

FIG. 7 is an enlarged view of a pin section.

FIG. 8 is an axial cross-sectional view showing a pin threading in its entirety.

FIG. 9 is an axial cross-sectional view showing a box section in its entirety.

FIG. 10 is an axial partial-cross-sectional view showing a box section in its entirety.

FIG. 11 is a further axial cross-sectional view showing a pin thread in its entirety.

FIG. 12 is an axial cross-sectional view showing a pin section, of a double-start thread.

FIG. 13 is a view similar to FIG. 12 showing a single start thread.

FIG. 14 is an enlarged view of a pressure flank of a pin or box thread showing a first embodiment thereof.

FIG. 15 is an enlarged view as in FIG. 14 showing a second embodiment thereof.

FIG. 16 is an enlarged view of an embodiment of FIG. 14, showing tangent lines and other aspects thereof.

FIG. 17 is an axial sectional view showing a shoulder portion of a pin segment according to a further embodiment.

FIG. 18 is an axial sectional view showing an end face portion of a pin segment according to the embodiment of FIG. 17.

FIG. 19 is an enlarged axial cross section of a shoulder portion of a pin thread according to one aspect; the box thread shoulder is similar.

FIG. 20 is an enlarged cross section of an end portion of a pin thread according to one aspect; the end portion of the box thread is similar.

FIG. 21 is an enlarged axial cross-section view of a further embodiment, showing a portion of a box thread.

FIG. 22 is an enlarged axial cross-sectional view according to the embodiment of FIG. 21, showing a portion of a pin thread.

FIG. 23 is an axial cross sectional view showing pin and box threads according to a still further embodiment.

FIG. 24 is a graph showing stress concentrations.

FIG. 25 is an enlarged view of a pressure flank of a pin or box thread showing a further embodiment thereof.

FIG. 26 is an enlarged view of a pressure flank and opposing clearance flank of a pin or box thread showing a still further embodiment thereof.

FIG. 27 is an enlarged sectional view showing the make up of box and pin threads according to an embodiment.

FIG. 28 is an enlarged section view comparing the expected fracture point of a thread in various embodiments.

FIG. 29 is a graph showing tensile strength.

FIG. 30A is a perspective side view of a pin before threading.

FIG. 30B is a perspective side view of the pin in FIG. 30A after threading.

FIG. 31A is a perspective side view of a standard clipping or tailing.

FIG. 31B is an enlarged partial view of portion A of FIG. 31A, illustrating removal of partial thread.

FIG. 31C is an enlarged partial view, illustrating a ramping effect when the clipped section of the first thread of the pin in FIG. 31B is parallel to the box.

FIG. 32A is a perspective side view of the threaded pin.

FIG. 32B is an enlarged partial view of portion C in FIG. 32A.

FIG. 32C is an enlarged partial view, illustrating a ramping effect when the clipped section of the first thread of the pin in FIG. 32B is parallel to the box.

FIG. 33A is a perspective side view of a pin with a clipping or tailing, according to an embodiment.

FIG. 33B is an enlarged partial view of the portion D of FIG. 33A, according to an embodiment.

FIG. 33C is an enlarged partial view of the portion D of FIG. 33A, according to another embodiment.

FIG. 33D is an enlarged partial view, illustrating alignment of the clipped section of the first thread of the pin of FIG. 32B with the box.

FIG. 33E is a front view of the threaded pin in FIG. 33A.

FIG. 33F are cross-sectional view of the threaded pin in FIG. 33E along lines A-A to F-F.

FIG. 34 is an enlarged partial view of a tapered leading section, according to another embodiment.

### DETAILED DESCRIPTION

The following is a detailed description of certain embodiments of the invention. The present description is not intended to limit the scope of the invention in any respect, including limiting the scope thereof to any of the specific aspects, features, details, dimensions or configurations provided in this detailed description.

### Definitions

For purposes of the present specification, the following definitions shall apply unless a different meaning is expressly stated or the context clearly requires a different definition.

“Rod”: means an elongate member that is threaded at one or both ends for coupling with a similar rod. A rod may be cylindrical or tapered and may have a solid or hollow core. A rod may be fabricated from any suitable material. The term “rod” may in some cases be used interchangeably with one or more of the terms “shaft”, “tube”, or “casing”.

“Thread” or “threading”: means a projecting rib or recessed groove, usually helical in configuration, which may be coupled together by threading to a similar “mating” thread.

“Box thread”: refers to the female threaded segment.

“Pin thread”: refers to the male threaded segment.

“Pressure flank”: refers to an essentially vertical or somewhat sloping surface on a thread forming between the root and crest surfaces. Normally, a pressure flank is brought into contact with a corresponding pressure flank when opposing threads are engaged with each other. The corresponding pressure flanks bear upon each other when axially load is induced on and the rod during makeup of a connection or a tensile load is applied during retraction of a drill string.

“Axial cross section”: refers to a cross section on a plane that bisects a rod through a central axis that extends between opposed ends of the rod.

“Transverse cross section”: refers to a cross section on a plane that is transverse to the central axis of the rod.

“Clearance flank”: is the flank extending between the root and crest of the threading, opposed to the pressure flank. Normally, a given clearance flank of a threading will remain out of contact with an opposed clearance flank of the mating threading when threaded together.

“Root”: refers to a cylindrical or frustoconical surface which extends between adjacent portions of a thread. The pin root is radially inward to the crest and the box root is radially outward to the crest and is normally parallel thereto. Normally, the root is co-axial with the central axis of the threading.

“Crest”: is a frustoconical or cylindrical surface which is normally parallel to the root. A crest is the surface between the pressure flank and clearance flank of a thread. The axis of the crest is normally co-axial with the central axis of the threading.

“Negative slope”: means a slope that provides an overhang between upper and lower portions of the negatively sloping surface whereby the uppermost portion of the sloping surface overhangs the lowermost portion. A negative slope normally defines a concave space beneath the overhang. For example, in FIG. 2 it will be seen that shoulder 30 defines a concave space when viewed in cross-section. In some cases, a surface may have multiple angles whereby a negative slope may have a positively sloping portion, even when the slope as a whole is negative.

“Interference fit”: means a configuration whereby the pin thread has a slightly larger outside diameter than the inside diameter of the contact surfaces of the box thread. The portions of the pin thread that contact the box thread when fully tightened force a slight expansion of the box thread segment, to secure the respective threaded components together.

“Proximal”: refers to a direction toward a point intermediate between opposing ends of the elongate tubular member 10 as described herein. “Distal” refers to an opposing direction towards one of the respective ends thereof.

“Buttress thread”: refers to a screw thread having one flank that is vertical while the other is inclined, and a flat top and bottom in order to combine efficiency in the transmission of power with strength. A buttress thread has a trapezoid or saw-tooth profile which is designed to handle high axial force in one direction. A buttress thread has a load-bearing face which is perpendicular to the central axis or a slight slope, such as 7° or less. The opposing face has a relatively shallow slope such as about 45°.

“Compound curvature”: refers to a curve made up of two or more circular arcs having different radii, which are joined tangentially without reversal of curvature.

“Clipping (or tailing)”: refers to the removal of the first partial thread which is caused by where the helical thread intersects the cylindrical chamfer between the pilot (major diameter on the pin) and the crest (minor diameter on the box). The cylindrical chamfer is un-helical or straight in nature and of where the pilot (root diameter at the distal end of the rod) meets the crest of the thread. The first partial thread is also where the clearance flank enters the cylindrical chamfer. This will gradually blend the first thread, from the pilot (root) up to the crest of the thread over approximately the first rotation of the thread creating a ramp like affect where the beginning of the tread at the root is approximately the same width as the crest of the thread.

“Jamming”: refers to the state where when the clipped sections of the first thread of the pin and box are parallel to one another and are aligned while making up the joint, a ramping effect will happen where the two members will try to “climb” one another forcing the diameter of the pin to compress inwards and the box outward causing them to bind or jam.

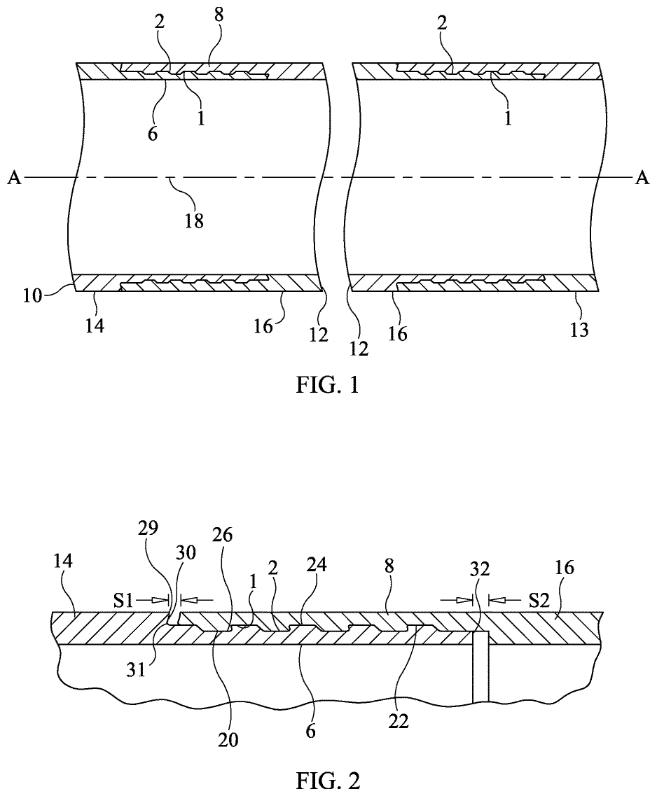

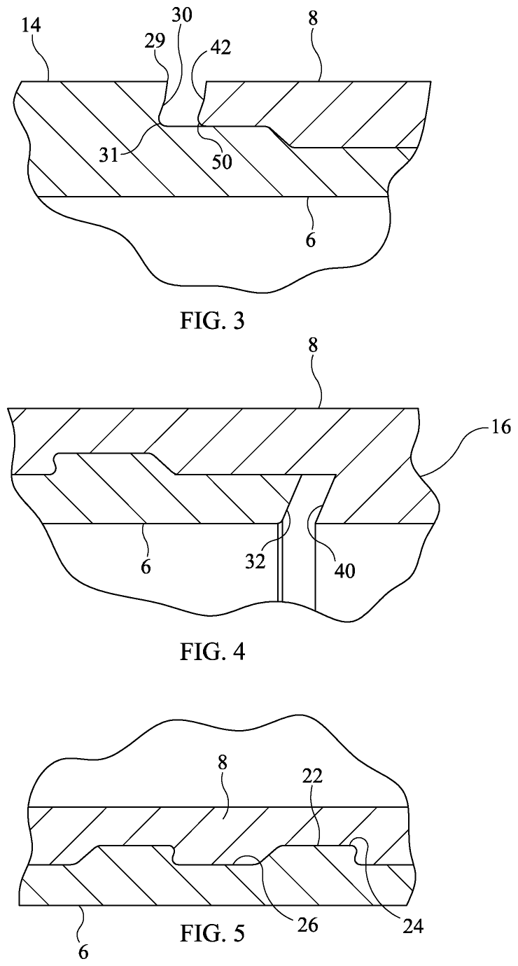

FIGS. 1-11 illustrate an embodiment of a modified buttress thread having a self-locking pressure flank. In this embodiment, the thread configuration relates to the threaded joint of a drill rod string. However, the present thread configuration has a range of applications, including use with a range of materials, fabrication methods and industrial applications. For example, without limitation, the thread configuration may be applicable for use with well casings, drilling tools and other components used for mineral and hydrocarbon exploration and environmental drilling.

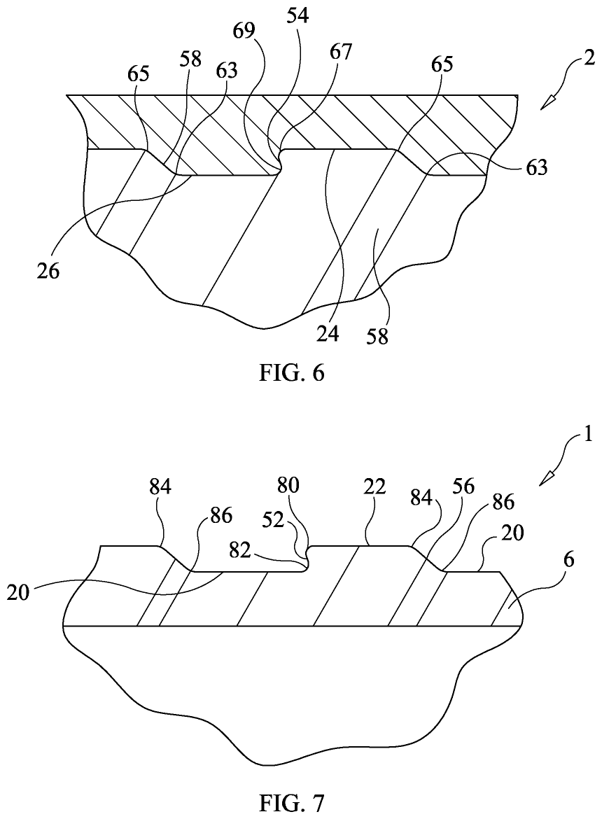

FIG. 1 depicts three tubular members 10, 12 and 13 which are essentially identical in structure and which may be coupled together in end to end fashion with threading provided at the respective ends thereof. The respective threading comprises a pin thread 1 (seen in more detail in FIG. 7) and a box thread 2 (seen in more detail in FIG. 6). An exemplary pin thread 1 is provided on a first end segment 6 of a first tubular member 10. A mating box thread 2 is provided on a second end segment 8, of a second tubular member 12. FIG. 1 also shows an opposing end of tubular member 12 comprising a pin thread 1. Thus, each tubular member 10 and 12 is provided with first and second threaded end segments 6 and 8 on opposing ends thereof. Tubular members 10 and 12 each further comprise a body 14 and 16 respectively, located between segments 6 and 8. A central longitudinal axis 18 extends axially between end segments 6 and 8 of each of members 10 and 12. When coupled together, the respective tubular members 10 and 12 are normally axially aligned, with a (normally) linear axis 18 extending between the opposing ends of the respective tubular members. It will be seen that a non-linear configuration may be provided, for example to accommodate a curved or arcuate drill string.

The outside diameter of tubular bodies 14 and 16 may be between 1.188″ to 6.5″ with a wall thickness of 0.188″ to 0.25″. The invention is not limited to these dimensions, nor to any particular dimensions identified in this specification.

As shown in FIG. 2, pin thread 1 is composed of a root surface 20 and a crest surface 22. Root and crest surfaces 20 and 22 lie on respective co-axial frustoconical (conical section) surfaces which are essentially planar when seen in cross section. The respective surfaces 20 and 22 are parallel to each other and taper inwardly by an angle of between 0.75 and 1.63 degrees relative to central axis 18 towards the distal end of threaded segment 6. Box thread 2 has a similar crest surface 26 and root surface 24 each being frustoconical and having a similar angle of taper of between 0.75 to 1.63 degrees inwardly towards the proximal end of segment 8. The respective threads 1 and 2 are configured to provide an interference fit between the pin crest and box root surfaces and a minimal clearance between the pin root and box crest when threaded together.

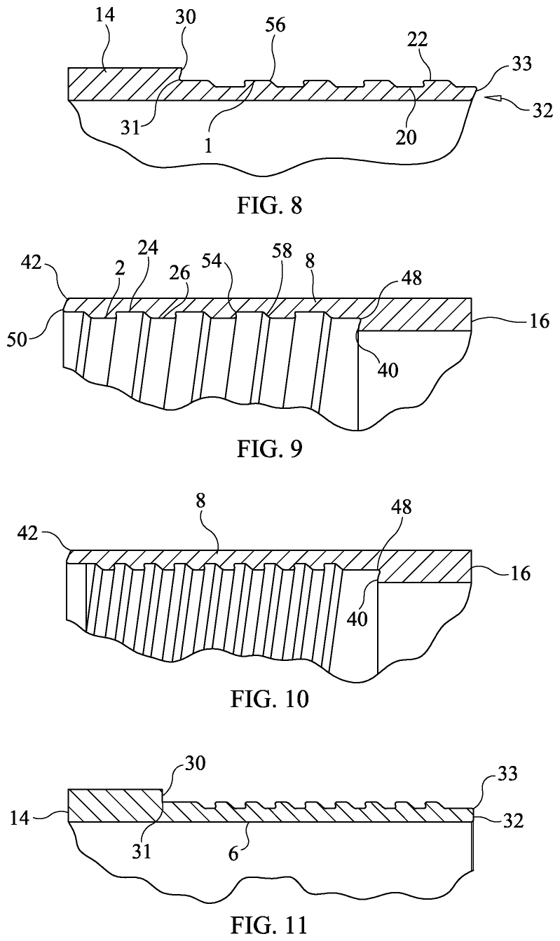

As seen more clearly in FIG. 8, body 14 of tubular member 10 is stepped radially inwardly at a shoulder 30, which defines the proximal margin of pin thread segment 6. Shoulder 30 has a negative slope of about 5-15° relative to axis 18 whereby body 14 overhangs the proximal margin of segment 6. A fillet 31 defines the inner corner between shoulder 30 and segment 6. Fillet 31 merges the surface of segment 6 with shoulder 30. An outer corner 29 is opposed to fillet 31 and defines the border between shoulder 30 and the outer surface of body 14. Segment 6 is defined at its opposed, distal end by an end face 32. End surface 32 has a positive slope similar to shoulder 30 (5-15°) and an outer fillet 33 with a radius of curvature similar to fillet segment 31. Fillet 33 is located at the radially outer corner of end face 32.

Fillet segments 33 and 50 may have a minimum radius of curvature of about 0.0156″ and fillet segments 31 and 48 may have a maximum radius of curvature of about 0.0156″. These respective dimensions provide minimal or no overlap in the respective radii of curvature so as to minimize or eliminate any interference between these segments when the members 10 and 12 are coupled together. Respective segments 33 and 50 are thus brought into abutting or adjoining relationship when the thread joint is fully made up without generating an interference fit between these respective regions. In more general terms, the radius of curvature of the concave shoulder fillet segments is greater than or equal to the radius of curvature of the corresponding abutting or adjoining convex end segment fillets.

As seen in FIGS. 2, 3 and 4, when the respective box and pin threads are coupled and the tubular members 10 and 12 are initially threaded together to a non-fully tightened position, a stand-off or gap remains between the respective end surface 42 of the box thread and shoulder 30 of the pin thread, and likewise between end surface 32 and box thread shoulder 40. At this initial pre-torqued stage, this gap is approximately 0.04-0.09 inches (see S1 in FIG. 2). When torqued to proper requirements, the end surface 42 of the box thread contacts shoulder 30 of the pin thread, while a gap or stand off exists of 0.001 to 0.004 inches between end face 32 of the pin thread and shoulder 40 of the box thread.

The pin and box threads 1 and 2 are configured to provide an interference fit, whereby the pin crest 22 has an outside diameter of about 0.002 to 0.004 inches larger than the inside diameter of box thread root 24. When fully made up, the crest 22 of the pin and the root 24 of the box thread has an interference fit of approximately 0.002 to 0.004 inches on the diameter while the pin root 20 and the box crest 26 has minor clearance to allow room for thread compound and debris. By increasing the radius in the corner of the root 24 and pressure flank 54, it decreases the stress concentration of the part.

The rear flank of the pin and box has the same geometry but the box thread depth is shallower than the pin thread depth by 0.002 to 0.005″ to provide interference between the pin crest and the box root and clearance between the pin root 20 and box crest 26. The box crest 26 extends off of a secant line and intersects to the rear flank radius.

As discussed above, the diameter of pin crest 22 is approximately 0.002 to 0.004 inches larger than the diameter of box root 24 so when the thread joint is made up “hand tight”, the pin major diameter will contact the box major diameter and there will be approximately 0.04 to 0.09″ standoff between the pin and box. When the joint is pre-torqued to the proper requirements, it will have an interference fit of approximately 0.002 to 0.004 inches on the diameter until the box face 42 and pin shoulder 30 fully contacts. At this point there will be a gap of 0.001 to 0.004″ between the pin face 32 and box shoulder 40.

The pin and box segments 6 and 8 have a theoretical length relative to the central axis of 1.6 to 2.6″ with the box segment 8 being longer than the pin segment 6 by up to 0.004″ to ensure proper make up.

As seen in FIGS. 6 and 7, pin and box threads have a pitch of 2 to 4 threads per inch, when provided on a single start thread. This value is doubled on an embodiment comprising a two-start thread, which comprises a paired helical threading and which is described below. The thread length relative to the central axis may be 1.6 to 2.6 inches, with the axial distance from the end face 42 to shoulder 40 of the box segment being longer than the corresponding distance of the pin segment by about 0.004 inches to ensure proper makeup. The pin crest diameter is approximately 0.002 to 0.004 inches greater than the box root diameter, to provide an interference fit.

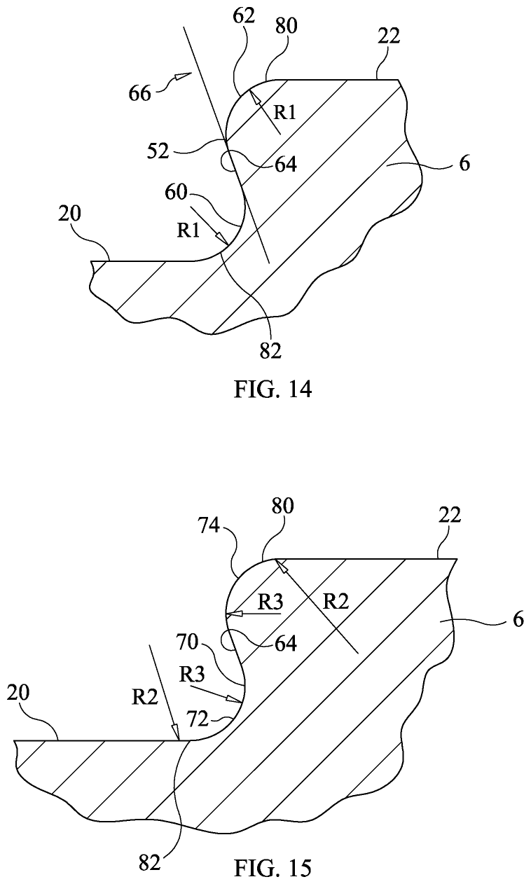

Referring to FIGS. 6 and 7, box thread pressure flank 54 and corresponding pin thread pressure flank 52 are shown, as well as pin thread clearance flank 56 and box thread clearance flank 58. Pin thread pressure flank 52 is shown in detail in FIGS. 14 through 16. Box thread pressure flanks 54 have identical mating configurations. FIG. 14 depicts a first embodiment of pressure flank 52 comprising an S-shaped cross-sectional configuration, composed of an inner concave section 60 and an outer convex section 62. Section 60 and 62 meet at inflection point 64. Surface 52 is thus continuously curved between root 20 and crest 22. Concave section 60 has a radius of curvature of R1, and convex segment 62 has an identical radius of curvature R1. At inflection point 64, surface 52 has a tangent angle 66. The slope of tangent angle 66 relative to axis 18, as well as the length of radius R1, determines the thread depth. Tangent 66 may comprise a negative angle of between 45 to 60 degrees relative to axis 18. The absence of flat surfaces on the respective pressure flanks allows the mating thread to lock while avoiding the compression characteristic of a conventional flat-surface reverse angle pressure flank.

The corresponding clearance flanks 56 and 58 are only in contact with each other until the pin shoulder 30 meets the box face 42. At this point, contact between the pin and box threads will shift to the respective rear pressure flanks 52 and 54. The threaded joint is then fully engaged. The initial relatively shallow attack angles of the clearance flanks 56 and 58 make it easier to start the thread by lining it up and reduce cross-threading.

The respective pressure and clearance flanks of the pin and box threads each meet the adjoining root and crest surfaces at a curved radius or fillet rather than a sharply-defined angle, as described herein. Turning first to the box thread 2 as seen in FIG. 6, a first convex radius or fillet 63 is provided at the intersection where clearance flank 58 meets box crest 26. A second concave fillet 65 is provided where box clearance flank 58 meets box root 24. A third convex fillet 69 is provided where box pressure flank 54 meets box crest 26 and a fourth concave fillet 67 is provide where box pressure flank 54 meets box root 24.

Turning next to pin thread 1 as seen in FIG. 7, pin thread 1 has a first convex fillet 80 where pin thread pressure flank 52 meets pin crest 22. A second concave fillet 82 defines the junction between pressure flank 52 and pin root 20. A third convex fillet 84 defines the junction between pin clearance flank 56 and pin crest 22 and a fourth concave fillet 86 defines the junction between pin clearance flank 56 and pin root 20.

It will be seen that when the pin and box threads are engaged, the respective convex fillets nest within the concave fillets. The radii of the respective convex fillets 63, and 84 are equal to or larger than the radii of the respective concave fillets 65, and 86 to ensure proper clearance during makeup of the joint.

The S-shaped curvature of pressure flank 52 provides a radius of curvature between pressure flank 52 and root 20. Increasing this radius causes a decrease of the stress concentration of the threading, as shown in the graph of Table 2 (see below).

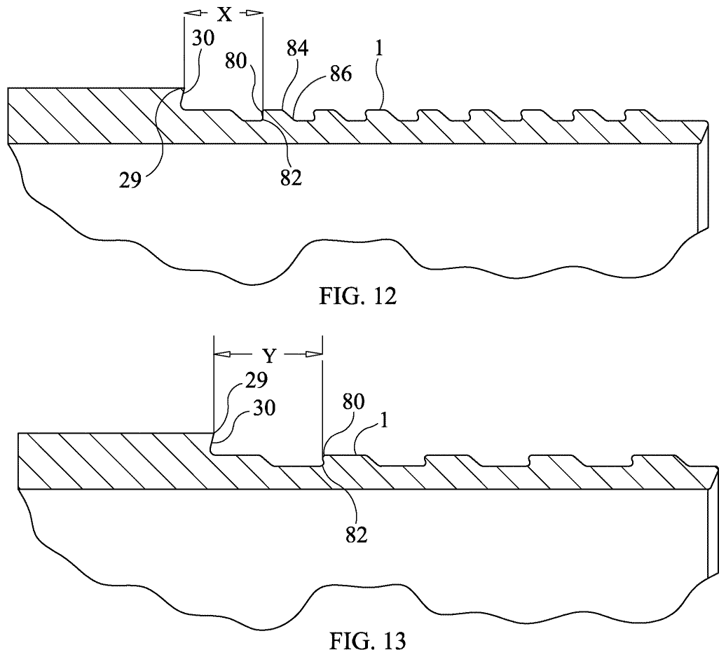

In one embodiment, pin and box threads 1 and 2 form a single start thread comprising an unpaired helix. In this embodiment, seen in FIG. 13, the thread has a pitch of 2.0 to 4 threads per inch. In a second embodiment, shown in FIG. 12, the thread has a double-start configuration that consists of a paired helical threading. In this embodiment, the thread pitch may be doubled from the below. One advantage of a double start thread is to provide increased contact area on the pressure flank which also reduces the distance between the last active thread and the shoulder which makes for a stronger and stiffer thread lead-in without compromising the number of turns required to fully make up the joint. This can also allow for a shorter thread lead-in adding additional strength to the joint.

The double start embodiment shown in FIG. 12 can have a “lead-in distance” x which is shorter than the corresponding “lead-in distance” y of the single start embodiment of FIG. 13. In the present embodiment, distance x is about 23% shorter than distance y. The “lead in distances” x and y comprise the axial spacing between the outer corner 29 that defines the edge of face 30 and fillet 52 that defines the margin between pressure flank 54 and crest 22 of pin thread 1. For purposes of measuring the lead-in distance, this measurement is derived from the proximal margin of pin thread 1, where pin thread 1 is closest to end face 30. The corresponding single start and double start embodiments of box threads 2 (not shown) have similar configurations to the pin threads of FIGS. 12 and 13.

FIG. 15 shows a second embodiment wherein pressure flank 70 comprises a similar S-shaped curve extending between root 20 and crest 22. However, pressure flank 70 differs from pressure flank 52 in that concave segment 72 is composed of a dual radius curved surface. Surface 72 is a compound curvature, a portion of which is comprised of a primary (major) radius of curvature R3 and the remainder of which is comprises a secondary (partial) radius of curvature R2, wherein R2 is greater than R3. One segment of concave portion 72 thus has a radius of curvature of R2 and is adjacent to root 20, while a second portion of segment 72 which is adjacent to inflection point 64 has a radius of curvature of R3. In a similar fashion, convex segment 74 has a compound curvature, composed of a first segment of radius R3 and an adjoining second segment of radius R2. Convex and concave segment 72 and 74 meet at an inflection point 64, having a tangent 66.

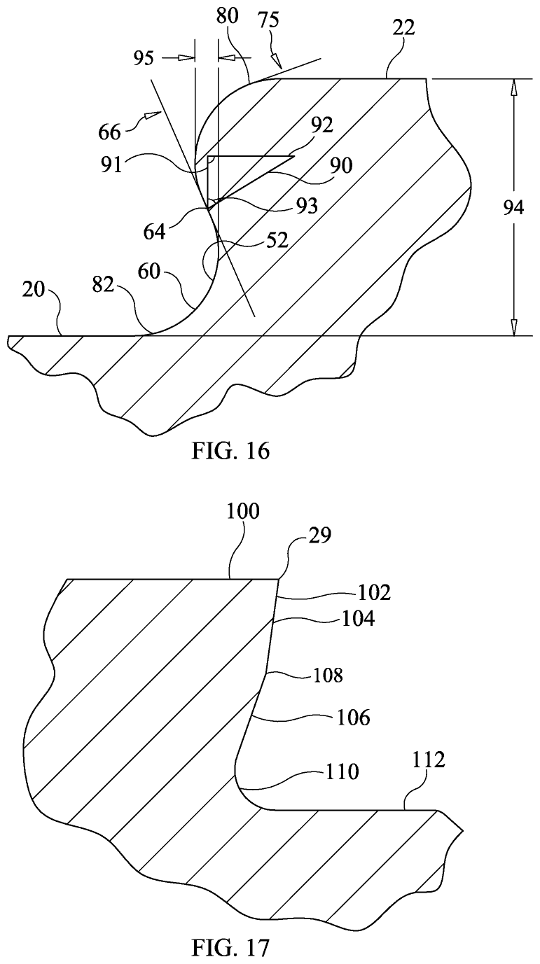

FIG. 16 provides additional details of the single radius curvature of the embodiment of FIG. 14. Pressure flank 52 can merge with crest 22 in a continuously curved arc. In one option, shown in a stippled 75 line in FIG. 16, pressure flank 52 can meet crest 22 at a flat surface 75 having a slope of 15° to 30° relative to crest 22. Flat surface 75 may be introduced in a machining process after the initial threading is cut. Flat surface 75 is provided to remove any irregularities that may have been introduced in the initial thread cutting step due to possible difficulties in cutting a smooth, continuously curved transition between flank 52 and crest 22. In this version, flat surface 75 has little or no significant effect on the performance of the thread.

Radius R1 combined with the tangent angle 66 effectively determines the thread depth between the respective root and crest surfaces and the quantum of interference 95 between respective pin and box pressure flanks (see Table 1).

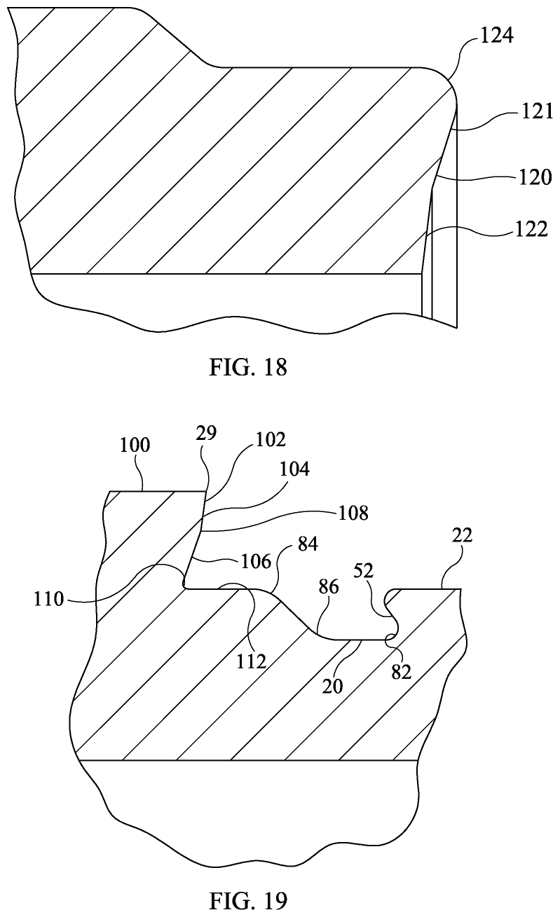

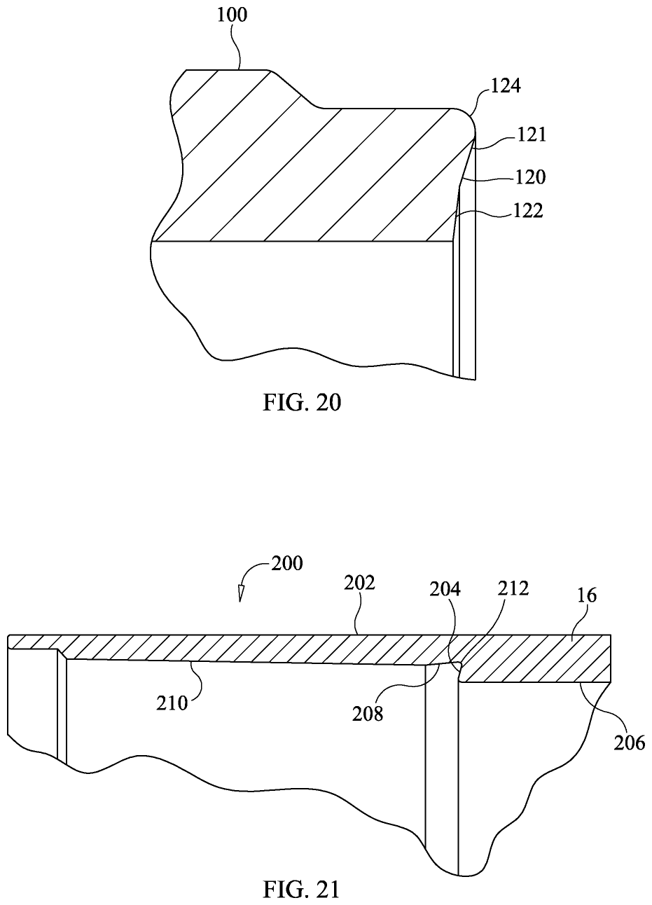

FIGS. 17 to 20 show a further embodiment of pin thread 100. In this embodiment, shoulder 102 (FIG. 17) has a compound negatively sloped surface consisting of an outer portion 104 and an inner portion 106. Outer portion 104 is perpendicular to axis 18 or has a negative slope of up to 4° relative to a perpendicular to axis 18. Inner portion 106 has a negative slope of between 12-15°. Portions 104 and 106 meet at an inflexion region 108 which is approximately the mid-point of shoulder 102. In one aspect, inflection region 108 has a minimum radius of curvature of 0.156″. Inner portion 106 meets segment 112 at a curved fillet 110. End surface 120, seen in FIG. 18 comprises a similar compound surface, consisting of an outer portion 121 with the same or similar taper as surface 106 and an inner surface 122 with the same or similar taper as surface 104. End surface 120 further comprises a rounded corner 124 having a similar radius as fillet 110. The pin shoulder 102 has a similar inflection region having a minimum radius of curvature of 0.156″.

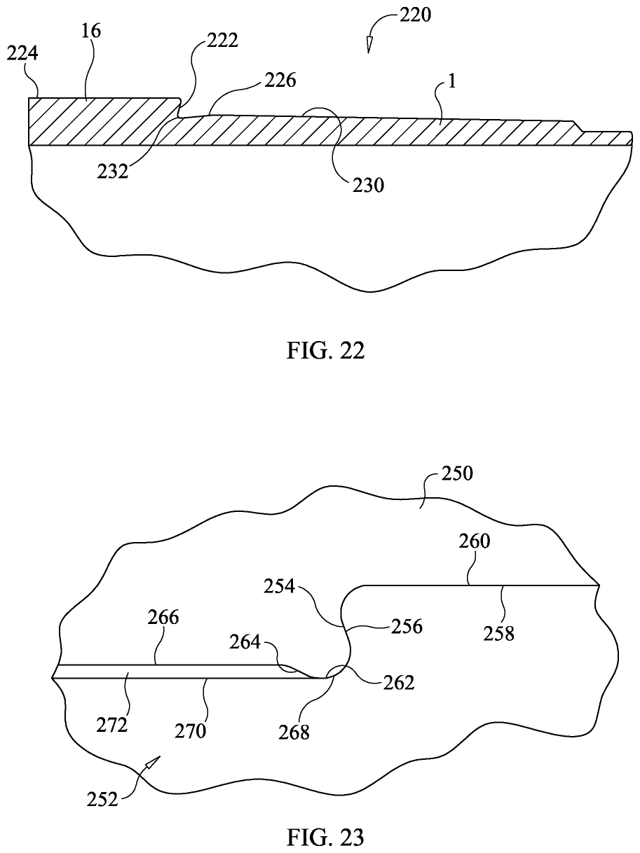

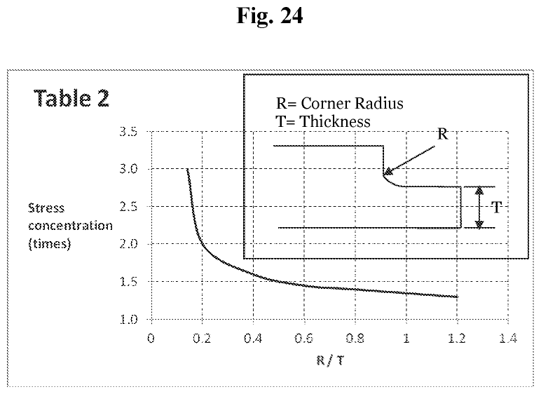

FIGS. 21 and 22 provide a further embodiment. FIG. 21 shows a proximal portion of a box thread 200 adjacent to body 16. Box thread 200 comprises an outer surface 202 which is continuous with the outer surface of body 16. Thread 200 comprises a shoulder 204, which comprises a tapered (frustoconical) annular surface that is undercut relative to the adjacent inner surface 206 of body 16. Shoulder 204 is perpendicular to the central thread axis or tapers outwardly (towards outer surface 202) and proximally and is within an angle of between 0° and 15°, preferably in the range of 5 to 15°, relative to a transverse (radial) plane of body 16.

Shoulder 204 merges with a tapered (frustoconical) ramp segment 208 which extends in a distal direction from shoulder 204. Ramp segment 208 slopes upwardly in a distal direction to merge with crest 210. As such, ramp segment 208 tapers outwardly in a proximal direction from crest 210 towards shoulder 204 to provide a radially enlarged segment of box thread 200. Ramp segment 208 is perpendicular to the central thread axis or has a slope of between 0° and 15°, preferably in the range of 5 to 10°, relative to the central elongate axis of body 16. The length of ramp segment 208 (proximal to distal ends thereof) is in the range of about 0.150-0.200 inches. Ramp segment 208 merges with shoulder 204 at a curved radius 212.

FIG. 22 shows a distal segment of a pin thread 220 that provides a complementary profile to box thread 200. Pin thread 220 is provided with a sloping (frustoconical) proximal shoulder 222 adjacent to outer surface 224 of body 16. Shoulder 222 has configuration that matches shoulder 204 of box thread 200, whereby shoulder 222 undercuts outer surface 224 and is provided with a taper of about 0-15° relative to a plane that transversely bisects body 16. Shoulder 222 merges with a ramp segment 226 which comprises a frustoconical surface having a taper of about 0-15° relative to the central elongate axis of body 16. Segment 16 tapers radially inwardly from adjacent to the innermost (proximal) pin crest surface 230, to reach a maximum diameter adjacent to shoulder 222. When seen in axial cross section as in FIG. 22, ramp segment 226 slopes downwardly towards proximal shoulder 222.

The length of ramp segment 226 matches box ramp segment 208, namely in the range of about 0.150-0.200 inches from the proximal to distal ends thereof. Ramp segment 226 merges with shoulder 222 at a radius 232.

In operation, in the embodiment of FIGS. 21 and 22, threads 200 and 220 are threaded together thereby bringing the respective pin and box threads into engagement. The effect of the ramp segments leads to the respective pin and box lead-in being pulled into the ramp rather than pushed out when a high level of torque or torsion is applied to the respective threads.

FIG. 23 shows box thread 250 and pin thread 252 according to a further embodiment. According to this embodiment, at least one of the pressure flanks of the pin and/or box threads comprises a projecting nose continuous with the pressure flank, such that the nose is adjacent to and merges with the corresponding crest. When the pin and box threads are engaged, the crest adjacent to the projecting nose crest becomes spaced apart from the root of the corresponding box or pin thread when threaded thereto.

According to this embodiment, the box and pin threads have S-curved pressure flanks 254 and 256 respectively. A flat crest 258 of pin thread 252 (at the major diameter of pin thread 252) is in contact with a flat root 260 of box thread 250 (at the major diameter of box thread 250) when threaded together. Box thread pressure flank 254 merges with an outer radius 262 at the minor diameter of box thread 250 (i.e. the innermost diameter). Outer radius 262 merges with a tapered segment 264 that angles outwardly towards the major diameter of box thread 250. As a result, radius 262 comprises a protruding nose when seen in an axial cross section (as in FIG. 23), which protrudes inwardly towards the central axis relative to the adjacent crest 266 of box thread 250. Crest 266 is thus recessed outwardly away from the central axis, when seen in axial section. In contrast, pressure flank 256 of pin thread 252 merges with a radius 268 which does not provide a similar nose-like projection.

It will be seen that nose 262 could alternatively or in addition be provided on the pin thread segment.

When box and pin threads 250 and 252 are threaded together, as seen in FIG. 23, crest 266 of box thread 250 is spaced apart from root 270 of pin thread 252, by a gap 272. It will be seen that gap 272 is formed and defined by the projecting portion of radius 262. Furthermore, this structure maximizes the thread flank contact between pressure flanks 254 and 256 without compromising the clearance between the adjacent crest and root segments 266 and 272 of box and pin threads 250 and 252.

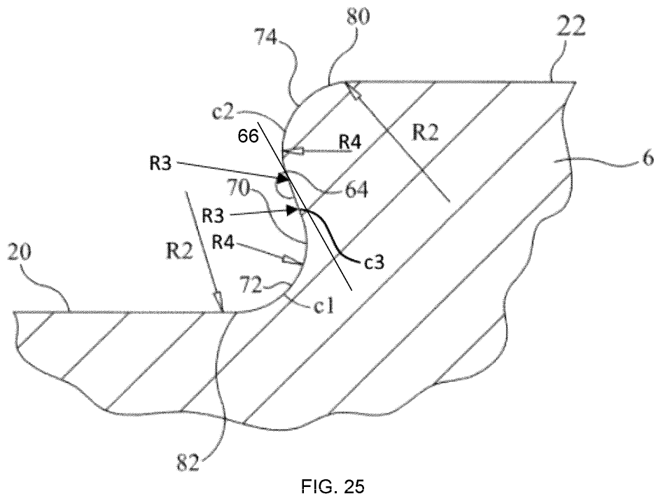

FIG. 25 illustrates a further embodiment, in which both the concave segment 72 and the convex segment 74 comprise a compound curvature. In this embodiment, the compound curvature of each segment 72, 74 comprises three distinct radii, making a triple radii compound curve. Similar to the embodiment shown in FIG. 15, each segment 72, 74 of the pressure flank 70 comprises a portion comprising a primary radius of curvature R3, and an additional radius of curvature R2. However, in this embodiment, a third radius of curvature R4 is included. In this embodiment, one segment of concave segment 72 thus has a radius of curvature of R2 and is adjacent to root 20, while a second portion of segment 72 adjacent R2 has a radius of curvature of R4, and a third portion of segment 72 that is between R4 and the inflection point 64 has a radius of curvature R3. In a similar fashion, convex segment 74 has a compound curvature, composed of a radius of curvature R3 adjacent the inflection point 64, followed by a second portion having a radius of curvature R4, and a third portion between R4 and the crest 22 having a radius of curvature R2. Convex and concave segment 72 and 74 meet at an inflection point 64, having a tangent 66. In one or both of the segments 72, 74, the radius R4 may instead be the radius closest to the root/crest 20, 22, or it may be the radius closest to the inflection point 64. In the embodiment shown in FIG. 25, the radius R4 is located in between R2 and R3 for each segment 72, 74. In this embodiment, R4 is equal to or less than R3, and less than R2. R4 in the concave segment 72 may have the same or different radius than R4 in the convex segment 74. The ratio of R2:R3 in one or both of the concave and convex segments 72, 74 is preferably in the range of 4:1 to 9:1, which provides increased mechanical properties in the threaded joint but may be limited to a lower ratio based on thread geometry.

In a further embodiment, the concave segment 72 has a triple radii compound curve and the convex segment 74 has a double compound curve, such as that shown in FIG. 15. Alternatively, in another embodiment, the concave segment 72 has a double compound curve, such as that shown in FIG. 15, while the convex segment 74 has a triple compound curve. In these embodiments, the triple compound curves are as discussed above.

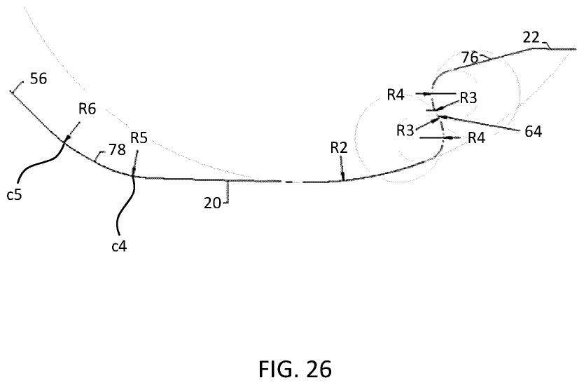

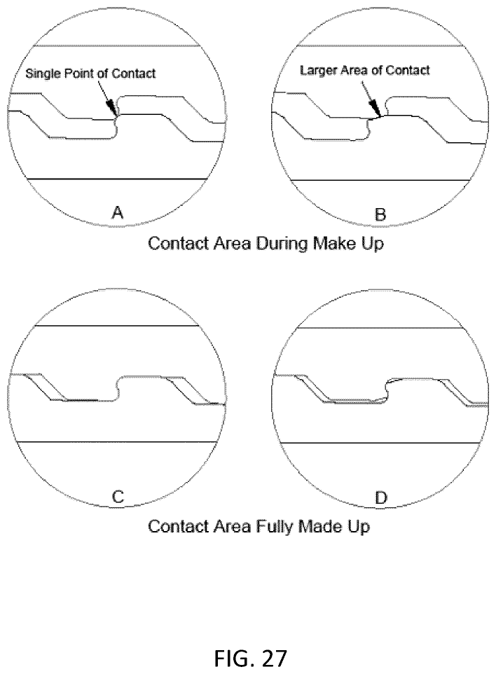

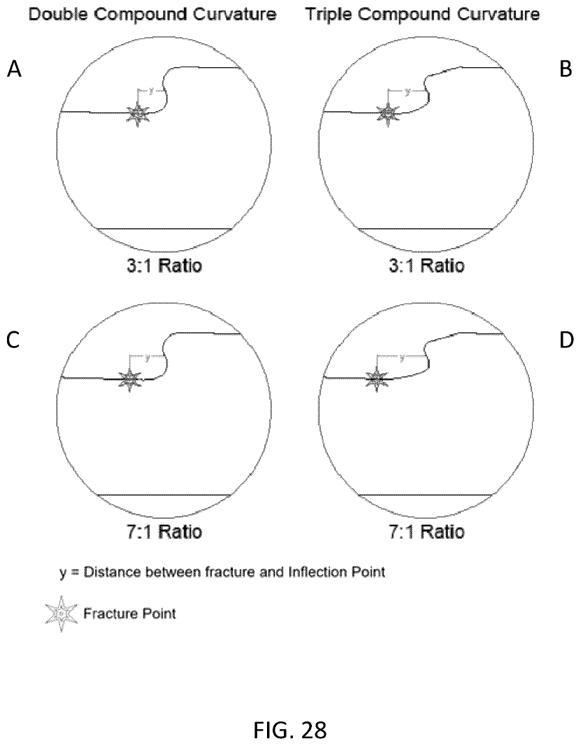

Another embodiment is shown in FIG. 26, in which a pressure flank 52 and the opposing clearance flank 56 can be seen. The pressure flank 52 of this embodiment is similar to that shown in FIG. 25, i.e. the concave segment 72 includes a triple compound curve having radii as discussed above. However, in this embodiment, a substantially linear tapered portion 76 in the convex segment 74, connecting the radius of curvature R4 with the crest 22. In this embodiment, there is a double compound curve in the convex segment having radii R3 and R4, in which the ratio of R3: R4 is 1:1 to 6:1. The tapered portion 76 assists in the alignment of the box thread 1 with the pin thread 2, and helps to distribute the load on the pressure flank 56 by increasing the area of contact to prevent or minimize premature wear during make up of the two threads (See e.g. FIGS. 27A and B). The tapered portion 76 will also provide a certain amount of clearance (See e.g. FIGS. 27 C and D) in the area prone to fracture (see e.g. FIG. 28) to minimize the effect that any wear on the thread crest 22 and pressure flank 56 has on this area. Preferably, the angle of the tapered portion 76 is 7 to 30 degrees relative to the crest 22.

Through a series of experiments, it is noticed that when a third curvature is added to the compound curve of the pressure flank 52, and preferably between R2 and R3, the distance from the inflection point 64 to where the thread failed (y in FIG. 28) is increased, without compromising or reducing the “self-locking” area of the pressure flank 52, which further strengthened the mechanical properties of the thread. This is at least due to the increase of thickness in the cross-section next to the pressure flank 52 that is realized by increasing the size of R2. This moves the thinnest portion of the thread toward the clearance flank 56, in which the thread becomes thicker due to the frustoconical shape of the joint.

In FIG. 26, a further embodiment of the clearance flank 56 is shown. In this embodiment, the clearance flank 56 also comprises a compound curvature. The clearance flank 56 has a curvature c4, which includes a first segment of the clearance flank 56 adjacent the root 20 having a radius of curvature of R5, while a second segment adjacent the first segment has a radius of curvature of R6. R5 is equal to or greater than R6, and equal to or less than R2. R5 and R6 may be connected tangentially, or alternatively, there may be a linear segment 78 that joins the two curves. This linear segment may be at an angle of 5-30 degrees relative to the root 20.

When certain embodiments of the present invention were tested, including those having a compound curvature in the pressure flank 52, in many instances the stress concentration in the area prone to failure, i.e. where the pressure flank 70 meets the root 20, decreased to the point that threads were often seen failing closer to where the root 20 meets the clearance flank 56 where the cross section is thicker, as opposed to where the root 20 meets the pressure flank 52 where the cross-section is thinner. Typically, previous testing of other products had produced a failure point where the root 20 meets the pressure flank 52 due to the thinner cross-section and high stress concentration. Adding a compound curvature to the clearance flank 56 reduces stress concentration and increases mechanical and fatigue properties. The compound curvature improves tensile strength, as will be discussed in detail in Example 4 below.

In an embodiment, there is provided a threaded joint for coupling together first and second members, each of said members having a central axis between respective ends thereof, said joint comprising: a pin thread segment at one end of said first member; and a tubular box thread segment at one end of said second member, said box thread segment and said pin thread segment each comprising: a helical thread defined by a pressure flank and a clearance flank spaced apart from each other with alternating roots and crests extending between said pressure flanks and clearance flanks, wherein said pressure flank comprises an S-curve extending between the root and the crest, said S-curve defined by a first curvature c1 adjacent to the root and a second curvature c2 adjacent to the crest, c1 and c2 curving in opposing directions with an inflection point between said curvatures c1 and c2, wherein c1, c2, or both c1 and c2, comprises: a compound curvature comprising a segment of a first circle having a radius R2, a segment of a second circle having a radius R3, and a segment of a third circle having a radius R4.

In any one of the preceding embodiments, c1 and c2 each comprise the compound curvature.

In any one of the preceding embodiments, in c1, the segment of the first circle is adjacent the root, the segment of the second circle is adjacent the inflection point, and the segment of the third circle is between the first and second circles.

In any one of the preceding embodiments, in c2, the segment of the first circle is adjacent the crest, the segment of the second circle is adjacent the inflection point, and the segment of the third circle is between the first and second circles.

In any one of the preceding embodiments, the ratio of R2:R3 is 4:1 to 9:1.

In any one of the preceding embodiments, R4 is equal to or smaller than R3.

In any one of the preceding embodiments, the clearance flank comprises a curvature c4 comprising a second compound curvature, the second compound curvature comprising a segment of a first circle having a radius R5, and a segment of a second circle having a radius R6.

In any one of the preceding embodiments, in c4, the segment of the first circle is adjacent the root.

In any one of the preceding embodiments, R5 is equal to or greater than R6.

In another embodiment, there is provided a threaded joint for coupling together first and second members, each of said members having a central axis between respective ends thereof, said joint comprising: a pin thread segment at one end of said first member; and a tubular box thread segment at one end of said second member, said box thread segment and said pin thread segment each comprising: a helical thread defined by a pressure flank and a clearance flank spaced apart from each other with alternating roots and crests extending between said pressure flanks and clearance flanks, wherein said pressure flank comprises an S-curve extending upward from the root toward the crest, said S-curve defined by a first curvature c1 adjacent to the root and a second curvature c2, c1 and c2 curving in opposing directions with an inflection point between said curvatures c1 and c2, wherein c1, c2, or both c1 and c2, comprises a compound curvature, and wherein a sloped linear segment connects the second curvature with the crest.

In any one of the preceding embodiments, in c1, the segment of the first circle is adjacent the root, the segment of the second circle is adjacent the inflection point, and the segment of the third circle is between the first and second circles.

In any one of the preceding embodiments, the compound curvature comprises a segment of a first circle having a radius R2, a segment of a second circle having a radius R3, and a segment of a third circle having a radius R4.

In any one of the preceding embodiments, R4 is equal to or smaller than R3.

In any one of the preceding embodiments, the ratio of R2:R3 is 4:1 to 9:1.

In any one of the preceding embodiments, the sloped linear segment has an angle of 7 to 30 degrees relative to the crest.

In any one of the preceding embodiments, the clearance flank comprises a curvature c4 comprising a second compound curvature, the second compound curvature comprising a segment of a first circle having a radius R5, and a segment of a second circle having a radius R6.

In any one of the preceding embodiments, in c4, the segment of the first circle is adjacent the root.

In any one of the preceding embodiments, R5 is equal to or greater than R6.

In another embodiment, there is provided a threaded joint for coupling together first and second members, each of said members having a central axis between respective ends thereof, said joint comprising: a pin thread segment at one end of said first member; and a tubular box thread segment at one end of said second member, said box thread segment and said pin thread segment each comprising: a helical thread defined by a pressure flank and a clearance flank spaced apart from each other with alternating roots and crests extending between said pressure flanks and clearance flanks, wherein said pressure flank comprises an S-curve extending upward from the root toward the crest, said S-curve defined by a first curvature c1 adjacent to the root and a second curvature c2, c1 and c2 curving in opposing directions with an inflection point between said curvatures c1 and c2, wherein c1, c2, or both c1 and c2, comprises a first compound curvature, and wherein the clearance flank comprises a curvature c4 comprising a second compound curvature, the second compound curvature comprising a segment of a first circle having a radius R5, and a segment of a second circle having a radius R6.

In any one of the preceding embodiments, in c4, the segment of the first circle is adjacent the root.

In any one of the preceding embodiments, R5 is equal to or greater than R6.

In any one of the preceding embodiments, in c1, the segment of the first circle is adjacent the root, the segment of the second circle is adjacent the inflection point, and the segment of the third circle is between the first and second circles.

In any one of the preceding embodiments, the first compound curvature comprises a segment of a first circle having a radius R2, a segment of a second circle having a radius R3, and a segment of a third circle having a radius R4.

In any one of the preceding embodiments, the ratio of R2:R3 is 4:1 to 9:1.

In any one of the preceding embodiments, a sloped linear segment connects the second curvature with the crest.

In any one of the preceding embodiments, the sloped linear segment has an angle of 7 to 30 degrees relative to the crest.

In any one of the preceding embodiments, the crest and root surfaces of said box and pin thread segments each define a frustoconical surface.

In any one of the preceding embodiments, the angle of taper of said frustoconical surface is within the range of 0.75 and 1.63 degrees relative to said central axis.

In any one of the preceding embodiments, said pin thread segment and said box thread segment each comprise a first and second unthreaded segments at opposing ends of said helical thread, said first unthreaded segment being at a distal end of said member and having an end face defining the distal end surface of said first member, said second unthreaded segment having a radially inwardly stepped shoulder.

In any one of the preceding embodiments, said shoulders are each angled relative to the perpendicular of said central axis at 5 to 15 degrees.

In any one of the preceding embodiments, said shoulders each comprise an inner portion adjacent to said unthreaded segment comprising a negative slope of 12° to 15° relative to the perpendicular of said central axis and an outer portion which is perpendicular to said central axis or has a negative slope of up to 4° relative to said perpendicular.

In any one of the preceding embodiments, said end faces each comprise a mirror-image configuration matching said shoulders.

In any one of the preceding embodiments, the threaded joint comprises a curved radius between said second unthreaded segment and said inner face.

In any one of the preceding embodiments, said clearance flanks are sloped relative to the central axis at about 45 degrees to about 60 degrees.

In any one of the preceding embodiments, said inflection point has a tangent with a slope relative to said central axis that is 45 degrees to 60 degrees.

In any one of the preceding embodiments, said helical thread comprises an unpaired helix comprising single-start thread or a paired helix comprising a double-start thread or a triple-start thread.

In any one of the preceding embodiments, said box thread segment and pin thread segment each comprise a distal end adjacent to an exposed end thereof and an opposed proximal end, said box thread segment comprising a recessed shoulder at the proximal end thereof and an innermost crest surface adjacent to said shoulder wherein said innermost crest surface comprises a frustoconical surface tapering inwardly towards the distal end, and wherein said pin thread segment comprises a recessed shoulder at the proximal end thereof and an innermost crest surface adjacent to said shoulder wherein said innermost crest surface comprises a frustoconical surface tapering inwardly towards the proximal end.

In any one of the preceding embodiments, the frustoconical surfaces of said pin and box thread segments have angles of taper that are substantially identical and which are in the range of about 0 degrees to about 15 degrees relative to a central axis extending between opposing ends of said member.

In any one of the preceding embodiments, said angle of taper is in the range of 5 degrees to 15 degrees.

In any one of the preceding embodiments, the shoulders of said pin and box thread segments taper inwardly in a proximal direction.

In any one of the preceding embodiments, said shoulders taper inwardly by substantially the same degree and are in the range of about 0 degrees to 15 degrees relative to a plane that transversely bisects said member.

In any one of the preceding embodiments, said angle of taper is in the range of 5 to 15°.

In any one of the preceding embodiments, at least one of said pressure flanks comprises a projecting nose continuous with said pressure flank, said nose being adjacent to and merging with the corresponding crest whereby said crest is spaced apart from the root of the corresponding box or pin thread when threaded thereto.

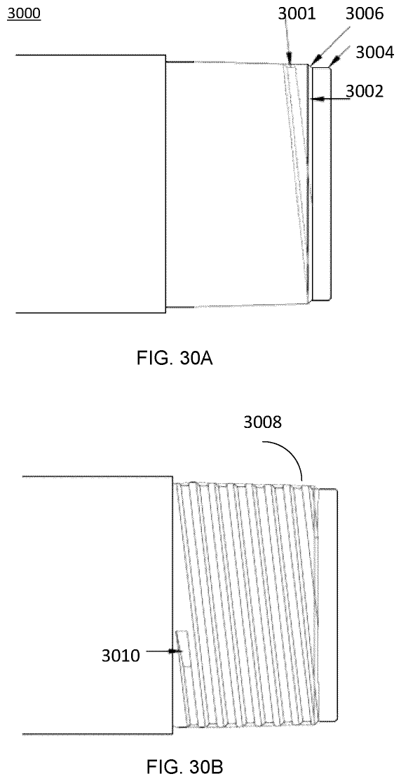

FIG. 30A illustrates an exemplary pin 3000 before threading. The pin 3000 includes a cylindrical body 3001, a pilot 3004, and a cylindrical chamfer 3006. In FIG. 30A, the pin 3000 includes a partial thread 3002. FIG. 30B illustrates the pin 3000 after threading. The threaded pin 3000 includes a helical thread 3008 on the cylindrical body 3001 of the pin 3000 and a thread pull-out 3010 where the threading tool retracted from the part adjacent to the shoulder during the manufacturing process. The ramp 3010 begins at the distal end of the thread root and blends out into the cylindrical body 3001 over a fraction of a revolution. The ramp 3010 may be cylindrical in nature or follow the helical thread path and is often limited by machine parameters. In order to prevent the first partial thread 3002 from contacting the thread pull-out 3010 of the mating part, the removal of the first partial thread is performed in a process referred to as “clipping or tailing”. If the clipping/tailing is not performed or not performed properly, the first partial thread 3002 can come in contact with the ramp caused by the thread pull-out 3010 of the mating part prior to the joint being fully made up. When this happens and an adequate amount of torque is applied to the threaded joint, the first partial thread will begin climbing the ramp causing the nose of the box to flare outwards over the pin shoulder and the nose of the pin to flare inwards past the box shoulder leading to premature failure of the treaded joint.

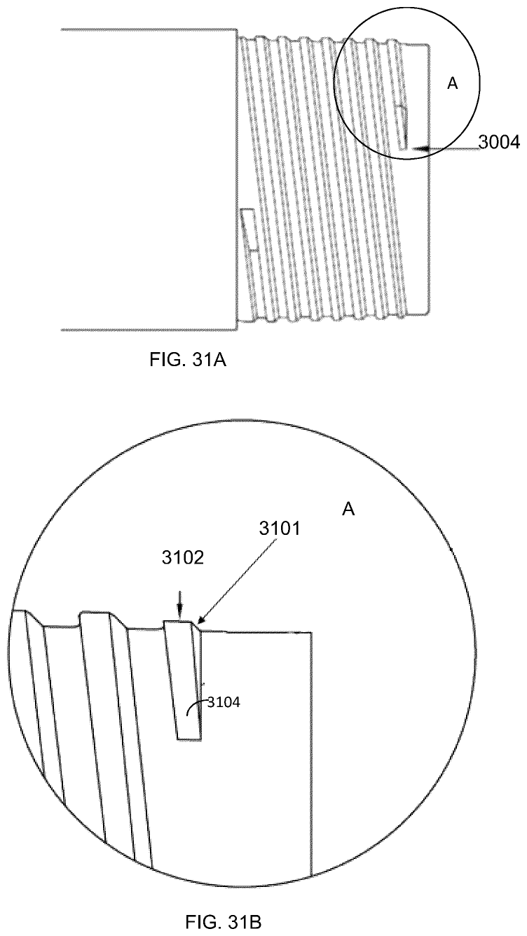

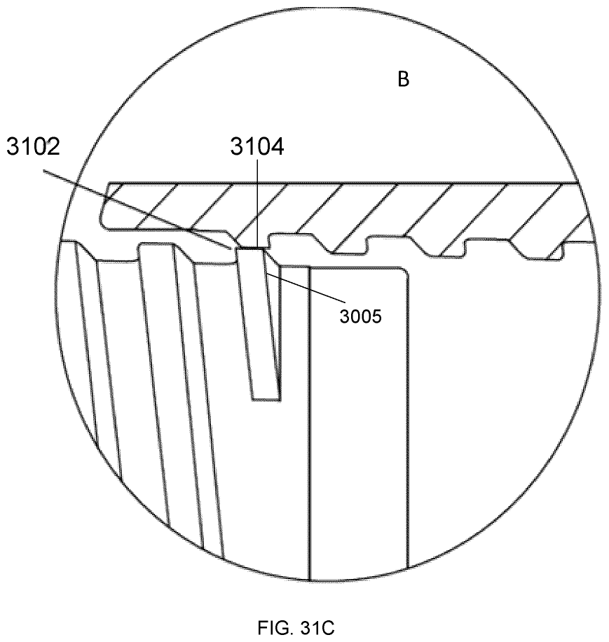

FIGS. 31A-31B illustrate a standard clipping or tailing, or modified Higbee cut. The clipping is the removal of the first partial thread of the thread 3008 parallel to the thread crest 3102, starting from the location where the helical thread 3008 substantially intersects the cylindrical chamfer 3006 between the pilot 3004 and the thread crest 3102. The thread 3008 is a buttress thread. The pilot 3004 is un-helical and substantially straight starting from the region where the pilot 3004, which corresponds to the root diameter at the distal end of the pin 3000, meets the crest 3102 of the thread 3008, and where the clearance flank enters the cylindrical chamfer 3006. It is also where the clearance flank 3005 enters the cylindrical chamfer 3006.

In the example of FIGS. 30A-31B, the body 3001 and the pilot 3004 are cylindrical and not helical in nature. In some examples, the body 3001 may be frustoconical and the pilot 3004 may be frustoconical or cylindrical.

In the example of FIGS. 31A-31B, the leading section 3101 is formed by removing a partial thread parallel to the thread crest 3102 to create a ramp 3104. In the example of FIGS. 31A and 31B, the leading section 3101 gradually blends the thread 3008, from the pilot 3004 up to the crest 3102 of the thread 3008 over approximately the first rotation of the thread creating the ramp 3104. The beginning of the leading section 3101 at the root is approximately the same width as the crest 3102 of the thread 3008.

However, with the ramp 3104, the thread 3008 of the pin 3000 and the thread of a box can climb each other and jam or cross thread 3008. This can cause severe damage to the pin 3000 or the box. In the example of FIG. 31C, when the clipped leading section 3101 or the ramp 3104 of the first thread 3008 of the pin 3000 and the crest 3104 of the box are parallel to one another and are aligned while making up the joint, a ramping effect occurs where the two crests 3102 and 3104 attempt to climb one another. The ramping effect forces the diameter of the pin 3000 to compress inwards and the diameter of the box outward, and causes the pin 3000 and the box to bind or jam. Due to the high forces applied by the drills, the ramping effect can cause premature and/or excessive wear of the threaded joint and can ultimately lead to catastrophic failure.

As illustrated in FIG. 31C, the clipped section of the first thread of the pin and box are parallel to one another and are aligned while making up the joint, due to a wide surface tailing, a ramping effect will happen where the two members will try to “climb” one another forcing the diameter of the pin to compress inwards and the box outward causing them to bind or jam. Due to the high forces applied by the drills, this can cause premature and/or excessive wear of the threaded joint and can ultimately lead to catastrophic failure.

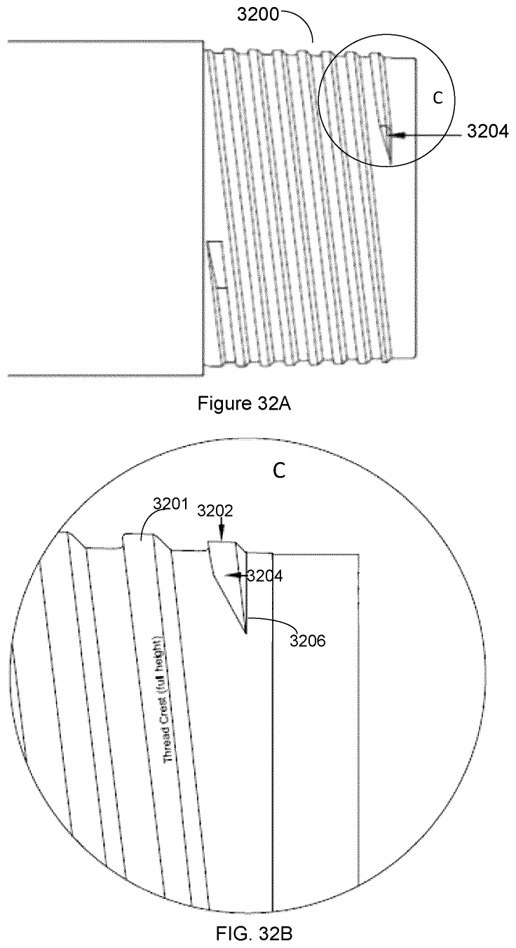

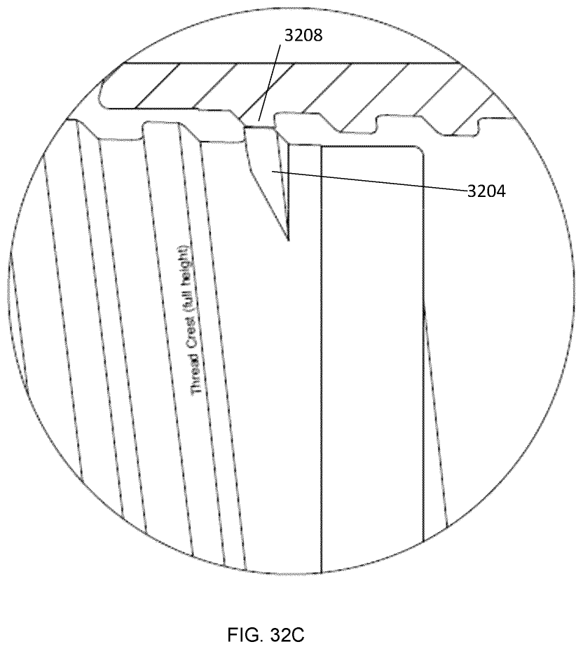

In an attempt to eliminate or reduce jamming, in the example illustrated in FIGS. 32A and 32B, a partial thread parallel to the crest 3202 of the thread 3200 is removed. Removal of partial thread parallel to the crest 3202 with increased angle helps align threads during makeup. In the example of FIGS. 32A and 32B, a ramp 3204 of an acute angle in relation to the root surface 3206 is formed at the start of the thread 3201 on the threaded pin 3200. As only a portion of the ramp 3204 is removed, and a section of the ramp 3204 remains. As illustrated in FIG. 32C, the ramp 3204 may align with the ramp 3208 of the mating part, including a box, and this can still cause a ramping effect and jamming the threaded pin and the mating part. As well, the ramp 3204 perpendicular to the crest 3202 can also cause jamming if the first thread from the pin 3200 and the mating part box line up during makeup.

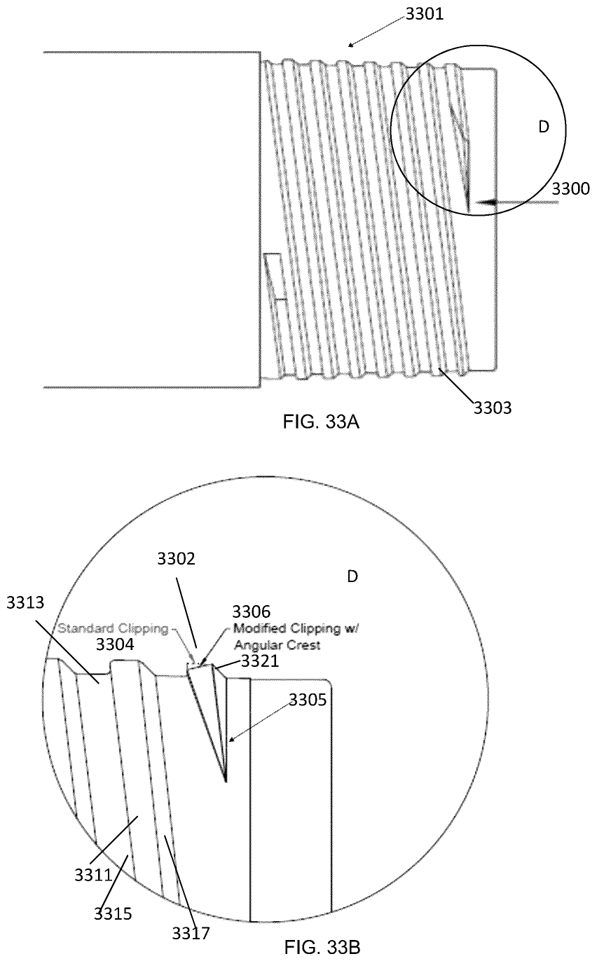

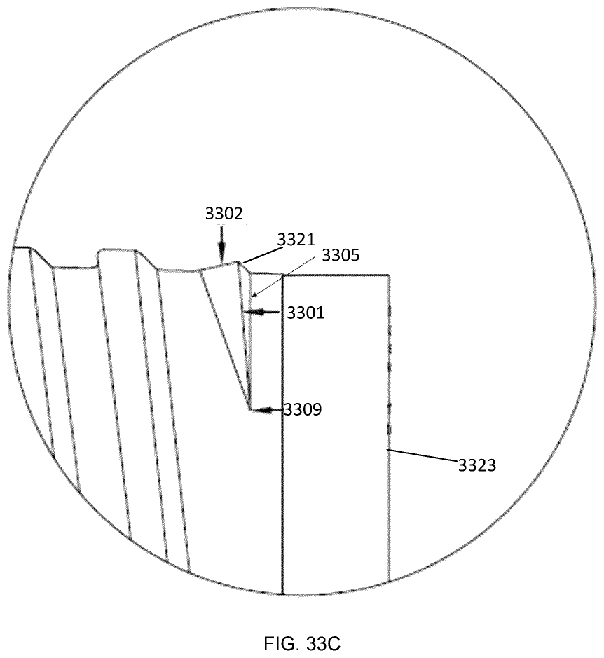

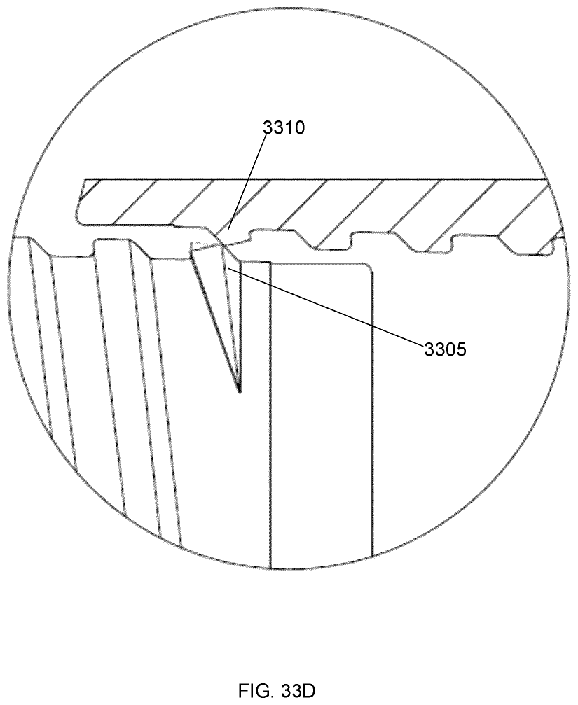

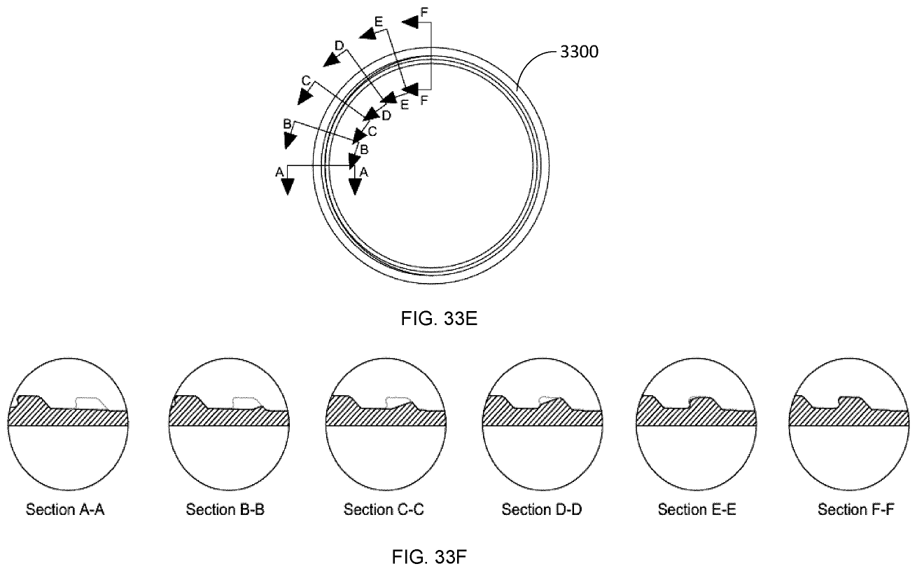

FIGS. 33A-33F illustrate an example of a buttress threaded pin 3300 with a clipping or tailing, according to an embodiment. In some examples, a threaded joint part, such as the threaded pin 3300 or a threaded box, may include a body 3301. A helical thread 3303 has a trapezoid profile and extending around the body 3301. The helical thread 3303 has flat crests 3311 and flat roots 3313, a pressure flank 3315 and a clearance flank 3317 spaced apart from each other with alternating roots 3313 and crests 3311 extending between the pressure flank 3315 and the clearance flank 3317. As illustrated in the example of FIGS. 33B and 33C, the helical thread 3303 has a tapered leading section 3305 which includes a first end 3309 and second end 3321. The first end 3301 may start proximate at a distal end 3323 of the body 3301. The tapered leading section 3305 is tapered from the second end 3321 to the first end 3309. The threaded pin 3300 may also include an angular crest 3306 located between the second end 3321 of the tapered leading section 3305 and the flat crests 3311.

The threaded joint part may also be a threaded box having a helical thread formed in the same manner as helical thread 3303.

In the example of FIGS. 33A-33F, by introducing an angle to the crest to form an angular crest 3306 for the full length of the clipping at the tapered leading section 3305 of the thread 3303, the threaded pin 3300 substantially eliminates any chance of jamming. In the embodiment of the threaded pin 3300, the angular crest 3306 may be formed, for example as illustrated in FIG. 33B, the, by removing a portion of a flat crest 3311 at a negative angle in relation to the flat crest 3311 from the flat crest 3311 towards the second end in additional to the standard clipping 3304.

In the example of FIGS. 33A-33F, the first end 3309 may be a point. The tapered leading section 3305 may have a top surface with an acute angle in relation to a central axis of the body at a distal end of the body. In the example of FIGS. 33A-33D, the tapered leading section 3305 may be substantially a triangular pyramid, and the tapered leading section 3305 may be formed with all the flat crest 3311 removed and all the pressure flank 3315 removed.

Clipping of the threaded pin 3300 may be manufactured in 2 steps. In the first step, the tapered leading section 3305 may be formed by removing removal of the partial thread, including a portion or all of the flat crest 3311 the pressure flank 3315, at the tapered leading section 3305. The removal of the partial thread may begin where the pilot diameter meets the root diameter. At the beginning of the clipping or root, the clipping may begin on the first thread rotation so that the width of the crest is much narrower and substantially a point 3309 and will gradually blend out to where the crest is at about its full width.

In the second step, a portion of the flat crest 3311 beyond the second end 3321 of the thread clipping is replaced by clipping with an angular crest 3306. At this step, the original portion of the crest 3311 at the standard clipping 3304 of the clipping is substantially removed to form a minimal flat or a slope down from the crest 3311 to the second end 3321. In some examples, the flat is substantially fully removed. The extent to remove the flat is based on certain thread features such as thread width, thread pitch, thread depth, length of clipping and angle of clipping crest. In some examples, the crest includes a flat which may have a width of no more than about 0.015-0.030″.

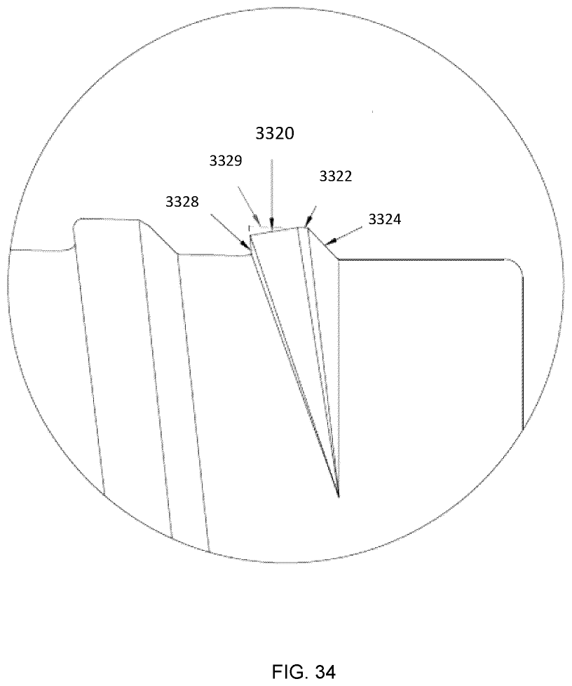

As illustrated in the example of FIG. 34, the tapered leading section 3305 may include at least a portion of the crest 3322 and at least a portion of pressure flank 3328. The flat crest 3322 may begin as far as possible on the clipping. The flat crest 3322 may begin preferably less than half of the clipping length.

As illustrated in the example of FIG. 33D, due to the reduced contact area of the crest 3311 of the tapered leading section 3305, the crest 3311 of the thread 3303 of the pin 3300 and the crest of the thread of the box 3310 are less likely to become parallel to one another and aligned while making up the joint, and a ramping effect become less likely to occur or may be eliminated. Therefore, the threaded pin 3300 can effective avoid jamming in makeup.

Once the angular clipping reaches the full length of the flat clipping to the actual crest 3311 of the thread, the angular crest 3306 is quickly blend out and reach full thread width of thread 3311 over a fraction of a revolution. The relatively small flat on the crest of the angular clipping can be controlled by changing the angle of cutting off the flat crest 3311. The angular clipping may gradually pull away from the root as the angular clipping becomes further away from the starting point 3309 in order to maintain a minimal crest flat. This also exposes a portion of the pressure flank 3328 where the tapered leading section 3305 meets the root 3315. However, the exposed pressure flank 3315 would not be an issue during make up.

In some examples, the clearance flank 3317 may have an angle of about 45-75.5 degrees to the center axis of the part or pin 3300, which can be made to substantially match the existing angle of the clearance flank 3317. The load or pressure flank 3315 may have an angle of about 10-30 degrees from the center axis of the part or pin 3300 to remove the existing crest.

FIGS. 33E and 33F illustrate cross-sectional profiles from the point 3309 to the full width of the crest of the tapered leading section of the threaded pin 3300. Line A-A is the point 3309 where the tapered leading section 3305 starts. The helical thread intersects the cylindrical chamfer 3006 between the pilot 3004 and the crest 3311 at the point 3309. Line F-F is at the first full thread, past the end of 3321 and where the clipping and angled crest 3302 is fully blended out to the original thread crest 3311.

### Example 1

Table 1 is a chart that provides an example of thread configurations in which radius R1 ranges from 0.008 inches to 0.012 inches with tangent 66 comprising either 45 degrees or 60 degrees relative to axis 18.

TABLE 1
Rear Pressure Flank Chart (See FIG. 16):

Radius (90)
Adjacent (91)
Opposite (92)
Angle (93)
Depth of Thread (94)
Interference (95)
Adjacent = (Radius) × (Cosine of angle)
Opposite = (Radius) × (Sine of angle)
Depth of thread = 2(Radius + Adjacent)
Interference = 2(Radius − Opposite)

45 Degree Tangent

| | | | | |
|---|---|---|---|---|
| Radius | .008″ | .009″ | .010″ | .011″ |
| Thread Depth | .0274″ | .0308″ | .0342″ | .0376″ |
| Interference | .0046″ | .0052″ | .0058″ | .0064″ |

60 Degree Tangent

| | | | | |
|---|---|---|---|---|
| Radius | .009″ | .010″ | .011″ | .012″ |
| Thread Depth | .027″ | .030″ | .033″ | .036″ |
| Interference | .0024″ | .0027″ | .0029″ | .0032″ |

### Example 2

Table 2 is a graph that illustrates the reduction in internal stress concentration as the radius increases of the fillet between the root and pressure flank of the box and pin threads according to one aspect of the invention.

By increasing the radius in the corner of the root and pressure flank, it decreases the stress concentration of the part

### Example 3: Measurement of Torsional Strength

An embodiment was tested for torsional strength. According to this test, three threaded pipe assemblies were provided, each assembly consisting of a pair of pipes threaded together. Each pipe had a 1 inch diameter hole for receiving a torque transfer shaft. An end plate adapter interface was provided for fastening to the torque transfer shaft, consisting of a pair of flanges with pins and holes for connecting the torque transfer shaft to a torsion device. Each assembly was attached at one end, through the flange, to a bearing block shaft and a sprocket. The opposed end of the assembly was secured against rotation by attachment to a vertical post via a pin. Torque was applied to the pipe in a counter-clockwise direction using a servo-hydraulic actuator equipped with a calibrated load cell and displacement transducer, through a chain and a clevis.

Rotation of the threaded joint was measured using a second calibrated displacement transducer installed directly on the tube at approximately 1 inch from the joint. Torque was applied to the tube using angular displacement control at a constant rate of 10°/minute until failure occurred to the threaded joint. Load and angular displacement at the tube were recorded and used to plot the torque vs. angular displacement curves.

### Example 4: Assessment of Tensile Strength

Multiple embodiments are tested to assess tensile strength. In this example, threads having a double compound curve in the pressure flank and exhibiting a ratio of R2:R3 of 3:1 or 7:1, are compared against threads having a triple compound curve in the pressure flank and exhibiting a ratio of R2:R3 of 3:1 or 7:1. These tested embodiments all include a linear tapered portion 76 in the convex segment 74, connecting the radius of curvature with the crest 22.

In this example, load to failure testing is conducted by fixing samples vertically into the jaws of a machine with machined plugs inserted into the end of the pipe, the test machine zeroed, and the testing carried out under direct tension at a constant speed until failure occurred. Tests are performed according to the testing requirements of ASTM E8/E8M: Standard Test Methods for Tension Testing of Metallic Materials.

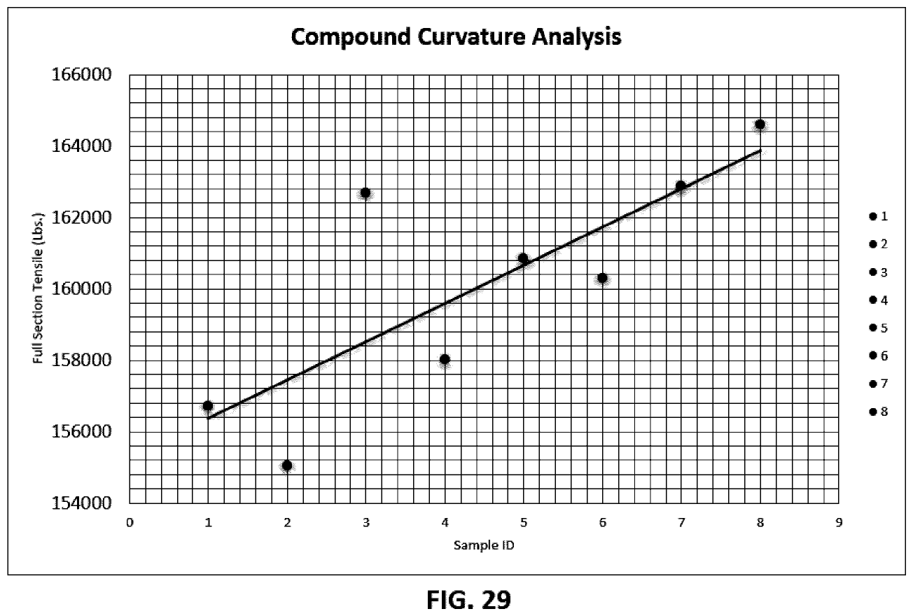

The results of this example can be seen in Table 3 below, and in FIG. 29. Among the threads having a double compound curve, increasing the ratio from 3:1 to 7:1 resulted in an increase of 2.86% in tensile strength. If the 3:1 ratio is maintained, but the pressure flank comprises a triple compound curve, an increase of 3% in tensile strength is realized. A thread having both the increased ratio of 7:1 and a triple compound curve performed the best, producing a 5.03% increase in tensile strength.

TABLE 3

| | | | Ultimate | | |
|---|---|---|---|---|---|
| Sam- | | | Load | | Increase |
| ple | Description | Ratio | (lbs.) | Average | (%) |
| 1 | Double Compound Curve | 3:1 | 156722 | 155889 | 0.00 |
| 2 | Double Compound Curve | 3:1 | 155056 | | |
| 3 | Double Compound Curve | 7:1 | 162679 | 160342 | 2.86 |
| 4 | Double Compound Curve | 7:1 | 158005 | | |
| 5 | Triple Compound Curve | 3:1 | 160852 | 160573 | 3.00 |
| 6 | Triple Compound Curve | 3:1 | 160294 | | |
| 7 | Triple Compound Curve | 7:1 | 162877 | 163734.5 | 5.03 |
| 8 | Triple Compound Curve | 7:1 | 164592 | | |

These results suggest that there are benefits to adding a third radius to the compound curvature of the pressure flank 52, as well as to increasing the ratio of curvature between R2 and R3 beyond a 3:1 ratio. This test suggests a gradual increase in performance as the radius (R2) becomes larger, but may be limited to a ratio of about 9:1 for practical reasons, such as in consideration of the clearance of the mating part of the opposing thread (see e.g. FIG. 27 D).

The scope of the present invention should not be limited by the preferred embodiments set forth in the examples but should be given the broadest interpretation consistent with the description as a whole. The claims are not to be limited to the preferred or exemplified embodiments of the invention.

1. A threaded joint for coupling together first and second members, each of said members having a central axis between respective ends thereof, said joint comprising:
a pin thread segment at one end of said first member; and
a tubular box thread segment at one end of said second member, said box thread segment and said pin thread segment each comprising:
a helical thread defined by a pressure flank and a clearance flank spaced apart from each other with alternating roots and crests extending between said pressure flanks and clearance flanks,
wherein said pressure flank comprises an S-curve extending between the root and the crest, said S-curve defined by a first curvature c1 adjacent to the root and a second curvature c2 adjacent to the crest, c1 and c2 curving in opposing directions with an inflection point between said curvatures c1 and c2,
wherein c1, c2, or both c1 and c2, comprises:
a compound curvature comprising a segment of a first circle having a radius R2, a segment of a second circle having a radius R3, and a segment of a third circle having a radius R4.

2.-3. (canceled)

4. The joint of claim 1, wherein the clearance flank comprises a curvature c4 comprising a second compound curvature, the second compound curvature comprising a segment of a first circle having a radius R5, and a segment of a second circle having a radius R6.

6.-10. (canceled)

11. The joint of claim 1, wherein in c1, the segment of the first circle is adjacent the root, the segment of the second circle is adjacent the inflection point, and the segment of the third circle is between the first and second circles.

12. (canceled)

13. The joint of claim 1, wherein R4 is equal to or smaller than R3.

14. The joint of claim 1, wherein the ratio of R2:R3 is 4:1 to 9:1.

15. (canceled)

16. The joint of claim 1, wherein the clearance flank comprises a curvature c4 comprising a second compound curvature, the second compound curvature comprising a segment of a first circle having a radius R5, and a segment of a second circle having a radius R6.

17. The joint of claim 6, wherein in c4, the segment of the first circle is adjacent the root.

18. The joint of claim 6, wherein R5 is equal to or greater than R6.

19. A threaded joint for coupling together first and second members, each of said members having a central axis between respective ends thereof, said joint comprising:
a pin thread segment at one end of said first member; and
a tubular box thread segment at one end of said second member, said box thread segment and said pin thread segment each comprising:
a helical thread defined by a pressure flank and a clearance flank spaced apart from each other with alternating roots and crests extending between said pressure flanks and clearance flanks,
wherein said pressure flank comprises an S-curve extending upward from the root toward the crest, said S-curve defined by a first curvature c1 adjacent to the root and a second curvature c2, c1 and c2 curving in opposing directions with an inflection point between said curvatures c1 and c2,
wherein c1, c2, or both c1 and c2, comprises a first compound curvature, and
wherein the clearance flank comprises a curvature c4 comprising a second compound curvature, the second compound curvature comprising a segment of a first circle having a radius R5, and a segment of a second circle having a radius R6.

20.-21. (canceled)

22. The joint of claim 19, wherein in c1, the segment of the first circle is adjacent the root, the segment of the second circle is adjacent the inflection point, and the segment of the third circle is between the first and second circles.

23. The joint of claim 19, wherein the first compound curvature comprises a segment of a first circle having a radius R2, a segment of a second circle having a radius R3, and a segment of a third circle having a radius R4.

24. (canceled)

25. The joint of any one of claim 19, wherein the first compound curvature comprises a segment of a first circle having a radius R2, a segment of a second circle having a radius R3, and a segment of a third circle having a radius R4.

26. (canceled)

27. The joint of claim 1, wherein the crest and root surfaces of said box and pin thread segments each define a frustoconical surface and wherein the angle of taper of said frustoconical surface is within the range of 0.75 and 1.63 degrees relative to said central axis.

28. (canceled)

29. The joint of claim 1, wherein said pin thread segment and said box thread segment each comprise a first and second unthreaded segments at opposing ends of said helical thread, said first unthreaded segment being at a distal end of said member and having an end face defining the distal end surface of said first member, said second unthreaded segment having a radially inwardly stepped shoulder.

30. The joint of claim 29, wherein said shoulders are each angled relative to the perpendicular of said central axis at 5 to 15 degrees.

31.-33. (canceled)

34. The joint of claim 1, wherein said clearance flanks are sloped relative to the central axis at about 45 degrees to about 60 degrees.

35. The joint of claim 1, wherein said inflection point has a tangent with a slope relative to said central axis that is 45 degrees to 60 degrees.

36. The joint of claim 1, wherein said helical thread comprises an unpaired helix comprising single-start thread or a paired helix comprising a double-start thread or a triple-start thread.

37. The joint of claim 1, wherein said box thread segment and pin thread segment each comprise a distal end adjacent to an exposed end thereof and an opposed proximal end, said box thread segment comprising a recessed shoulder at the proximal end thereof and an innermost crest surface adjacent to said shoulder wherein said innermost crest surface comprises a frustoconical surface tapering inwardly towards the distal end, and wherein said pin thread segment comprises a recessed shoulder at the proximal end thereof and an innermost crest surface adjacent to said shoulder wherein said innermost crest surface comprises a frustoconical surface tapering inwardly towards the proximal end.

38. The joint of claim 37, wherein the frustoconical surfaces of said pin and box thread segments have angles of taper that are substantially identical and which are in the range of about 0 degrees to about 15 degrees relative to a central axis extending between opposing ends of said member and wherein said shoulders taper inwardly by substantially the same degree and are in the range of about 0 degrees to 15 degrees relative to a plane that transversely bisects said member.

39.-43. (canceled)

44. A threaded joint part comprising:
a body,
a helical thread having a trapezoid profile and extending around the body, the helical thread having flat crests and flat roots, a pressure flank and a clearance flank spaced apart from each other with alternating roots and crests extending between the pressure flank and the clearance flank,
the helical thread having a tapered leading section having a first end and second end, the first end starting proximate at an end of the body, the leading section tapered from the second end to the first end,
an angular crest located between the second end of the tapered leading section and the flat crests.

45. The threaded joint part of claim 44, wherein the threaded joint part comprises a pin and wherein first end comprises a point.

46. (canceled)

47. The threaded joint part of claim 44, wherein the tapered leading section has a top surface with an acute angle in relation to a central axis of the body at a distal end of the body.

48.-49. (canceled)

50. The threaded joint part of claim 44, wherein the tapered leading section does not include the flat crest and does not include the pressure flank.

51. The threaded joint part of claim 44, wherein the tapered leading section includes at least a portion of the crest and at least a portion of pressure flank.

52. The threaded joint part of claim 44, wherein the helical thread is a buttress thread.

53. (canceled)
